(19) United States
(12) Patent Application Publication
(10) Pub. No.: US 2005/0183900 A1
(43) Pub. Date: Aug. 25, 2005

(54) Wheelchair

(76) Inventors: Gerold Goertzen, Brunswick, OH (US); Bradley Kushner, Elyria, OH (US); Damon Jurkiewicz, Lakewood, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/045,459

(22) Filed: Jan. 28, 2005

Related U.S. Application Data
(60) Provisional application No. 60/539,751, filed on Jan. 28, 2004.

(51) Int. Cl. B62M 1/14

(52) U.S. Cl. 180/311

(57) ABSTRACT

A wheelchair having a frame the includes first and second side portions, a seat assembly support portion, and a battery support portion is provided. The battery support portion is disposed substantially rearward of the seat assembly support portion and at least one drive wheel and at least one caster assembly supporting the wheelchair are provided. A method of promoting cognitive abilities of young users of wheelchairs or mobility aides is also provided.

### CROSS-REFERENCE TO RELATED APPLICATIONS

This application claims priority to Provisional U.S. Patent Application Ser. No. 60/539,751, filed Jan. 28, 2004 and titled “Wheelchair,” which is hereby fully incorporated by reference.

### BACKGROUND

Wheelchairs are an important means of transportation for a significant portion of society. Whether manual or powered, wheelchairs provide an important degree of independence for those they assist. As such, a need exists for a wheelchair that is suitable for the very young.

### SUMMARY

In one embodiment, a wheelchair having a frame the includes first and second side portions, a seat assembly support portion, and a battery support portion is provided. The battery support portion is disposed substantially rearward of the seat assembly support portion and at least one drive wheel and at least one caster assembly supporting the wheelchair are provided.

According to a second embodiment, a method of promoting cognitive ability in young users of wheelchairs is provided. The method includes, for example, providing a power mobility aide having a seating system, frame, drive system, and control system configured for a young user in the age range of less than two years old, receiving input control signals from a user input device controlled by the young user, and generating drive signals to drive the mobility aide according to the input control signals from the young user.

### BRIEF DESCRIPTION OF THE DRAWINGS

FIGS. 1-4 illustrate one embodiment of a wheelchair;

FIG. 5 is a perspective view of one embodiment of a frame;

FIG. 6 is perspective view of one embodiment of a chair having a backrest and seat.

FIGS. 7A and 7B are flowcharts of embodiments of a method of promoting cognitive development in young users of wheelchairs and mobility aides.

### DESCRIPTION

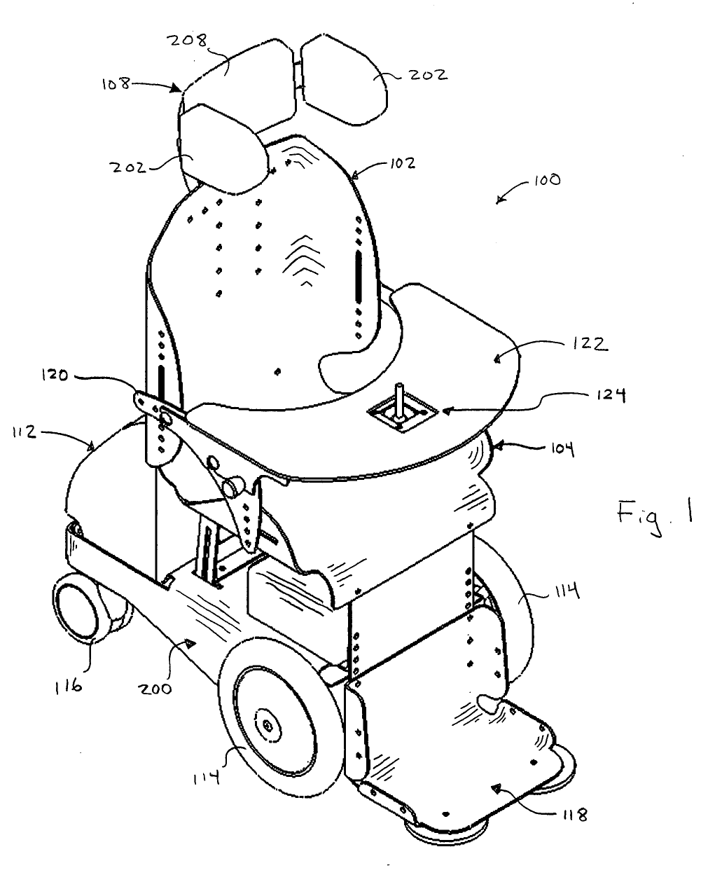

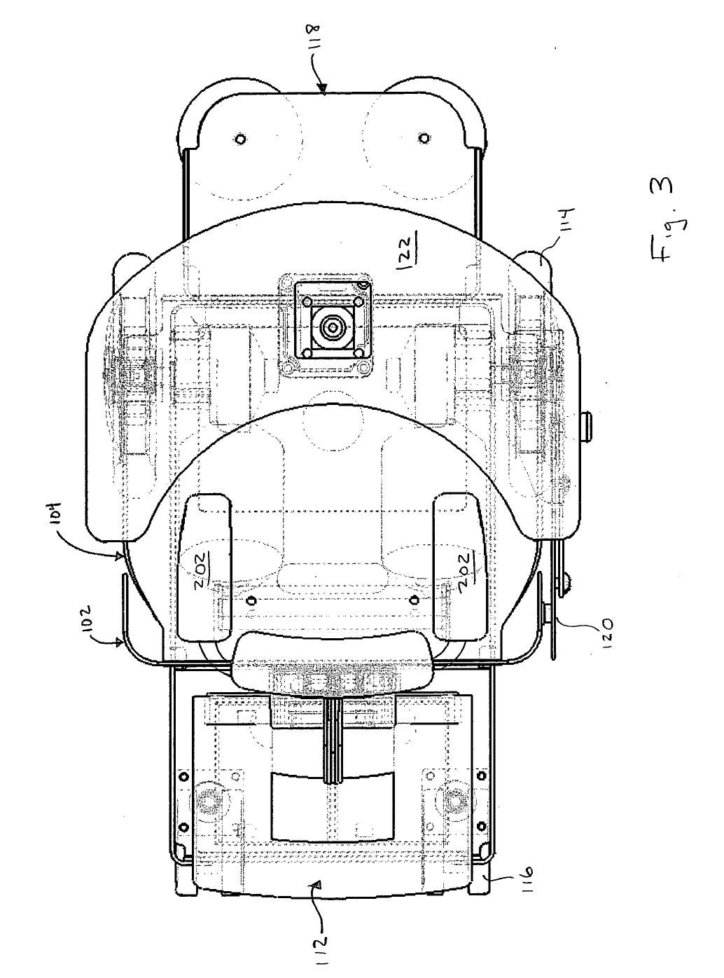

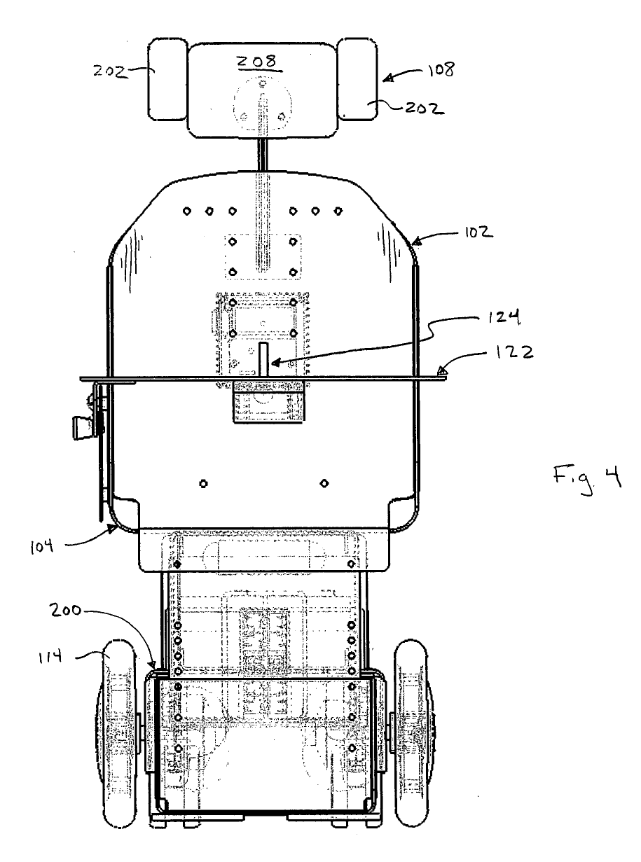

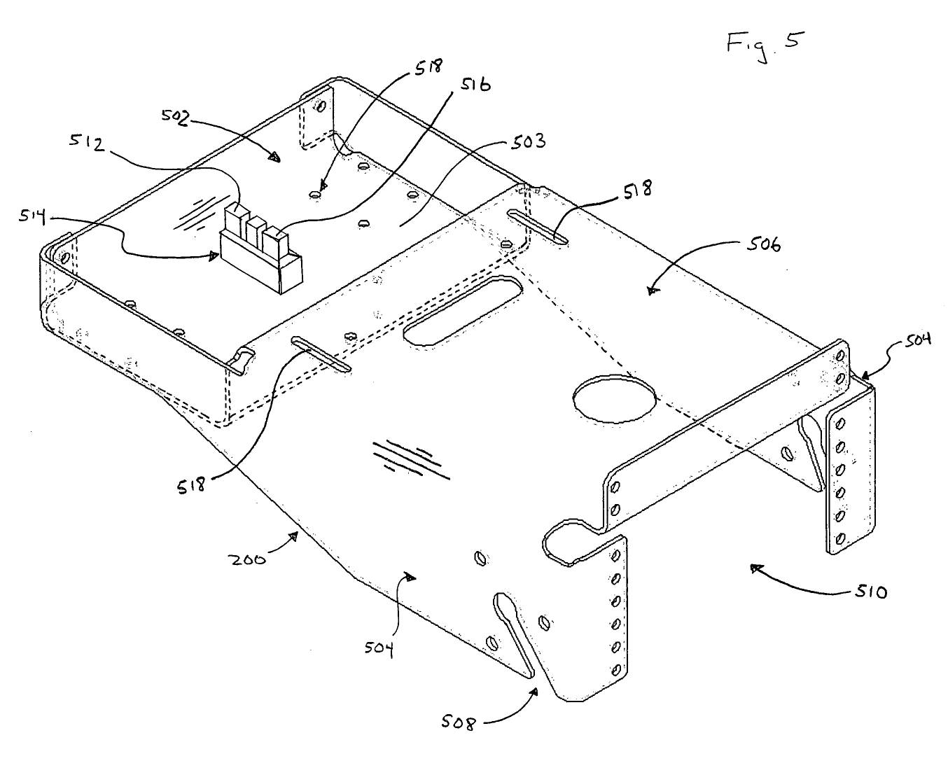

Referring to FIGS. 1-4, various views of one embodiment of a wheelchair 100 is shown. Wheelchair 100 has a chair having a backrest frame 102 and a seat frame 104. A comfortable material typically covers the face of the backrest frame 102 and seat frame 104, which may further include a cushion. Backrest frame 102 and seat frame 104 may be formed from a single piece (monolith) of material, such as, for example, sheet metal, metal, plastic and other materials. Alternatively, the backrest frame 102 and seat frame 104 can be formed of separate pieces and joined together.

A sidearm portion 120 is adjustably connected between backrest frame 102 and seat frame 104. Side arm portion 120 also braces these components together to control the adjustable angle between the components. In the present embodiment, an electronics box 110 is affixed to the rear of backrest frame 102. Electronics box 110 can include an on/off switch and a port for connecting other electronic devices thereto such as a remote control joystick. Though electronics box 110 is shown affixed to the back of backrest frame 102, it can be located on virtually any accessible portion of wheelchair 100. Electronics box 110 includes drive and control circuitry for sensing user input commands and generating drive signals for driving the motors of the wheelchair. A headrest assembly 108 is adjustably attached to backrest frame 102 and a tray 122 is adjustably attached to arms 120. Tray 122 may include a joystick controller 124 therein for receiving drive inputs from the user.

Wheelchair 100 also has frame 200 that accommodates a removable battery assembly 112 that reveals a battery compartment. Wheelchair 100 further includes drive wheels 114 and castor wheel 116. The other side of wheelchair 100 includes a similar drive wheel and a caster wheel. Each drive wheel is driven by an electric motor or electric motor/gearbox combination so as to form a drive assembly. While the present embodiment is shown with the drive wheels substantially beneath seat 104, the drive wheels may be moved to different positions along frame 200. A footrest 118 is provided forward of the seat frame 104 so as to provide a place for a user's legs.

A headrest assembly 108 has first and second bracket members 204 and 206, which are pivotally connected to each other through a pivot joint. Bracket 206 is further pivotally connected to backrest frame 102 through a mounting bracket that forms a pivot joint. Headrest assembly 108 further includes a headrest 208 and may incorporate a head-array having sensing elements 202 on both sides of headrest 208. The head-array is a device that is capable to providing directional input to a wheelchair controller for steering a power wheelchair. Sensing elements 208 may be capacitative such that when the head of a user comes close or in contact with element 208, a direction signal is generated and sent to the wheelchair controller via cable 210. The wheelchair controller then directs the wheelchair to travel in the specified direction. Headrest 208 is also pivotally connected to bracket 204 by a pivot joint.

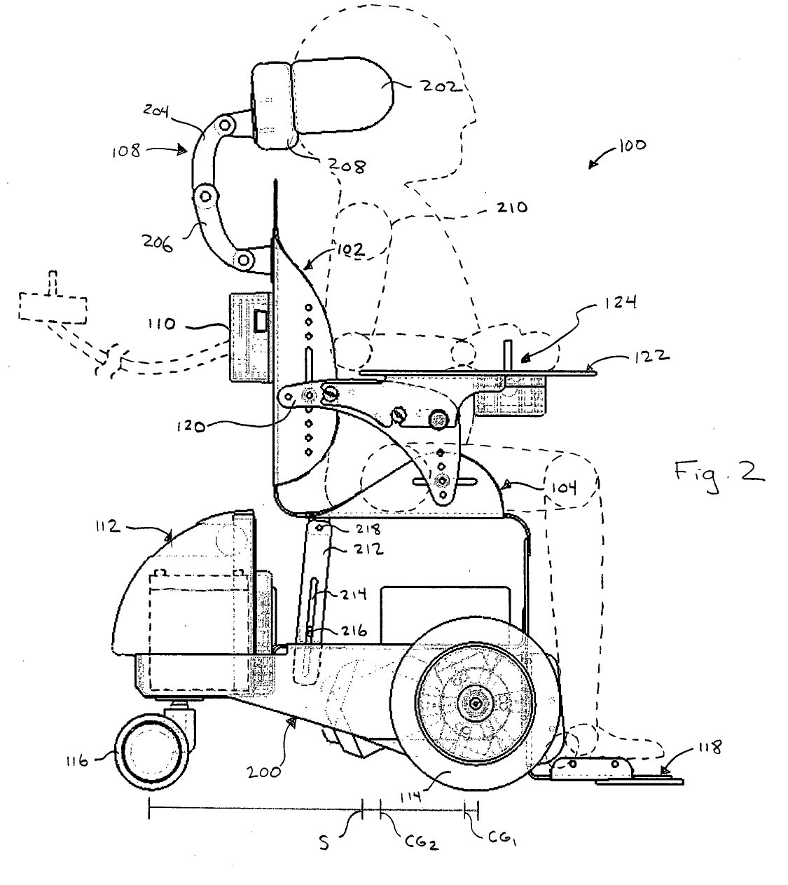

Frame 200 can also be formed from a single piece of material such as, for example, sheet metal, metal, plastic, and other materials. Frame 200 includes a top surface 506, side surfaces 504, and a battery compartment 502. Top surface 506 has a plurality of apertures and slots for accepting a variety of component. For example, slots 518 allow rear seat-to-floor height adjustment bracket 212 (FIG. 2) to telescope therefrom or thereinto. Side surfaces 504 include a drive wheel assembly mounting portion 508. Drive wheel assembly mounting portion 508 includes apertures for fastening the motor or gearbox of a drive assembly to frame 200 and a slot for allowing insertion of the drive wheel axel to the proper position. The forward portion 510 of frame 200 includes apertures that may be used for attaching the footrest, shroud and/or seat frame. The rear portion of frame 200 includes the battery compartment 502.

Battery compartment 502 houses batteries for powering the drive wheel assembly of the wheelchair and has a recessed bottom surface or pan 503 that includes a projecting electrical connector 514. Connector 514 includes alignment features 512 and 516 which assist in guiding a mating connector on a battery box into contact with connector 514. Alignment features 512 and 516 can be, for example, projecting tabs or prongs. In this respect, the mating connector on the battery box has complementary alignment features configured align and mate with connector 514.

The bottom surface or pan 503 of battery compartment 502 may also serve as a supporting or frame structure for the attachment of rear caster wheels. For example, bottom surface or pan 503 may include a plurality of apertures 518 for accepting a plurality of fasteners that are used to attach rear casters to the frame of the wheelchair.

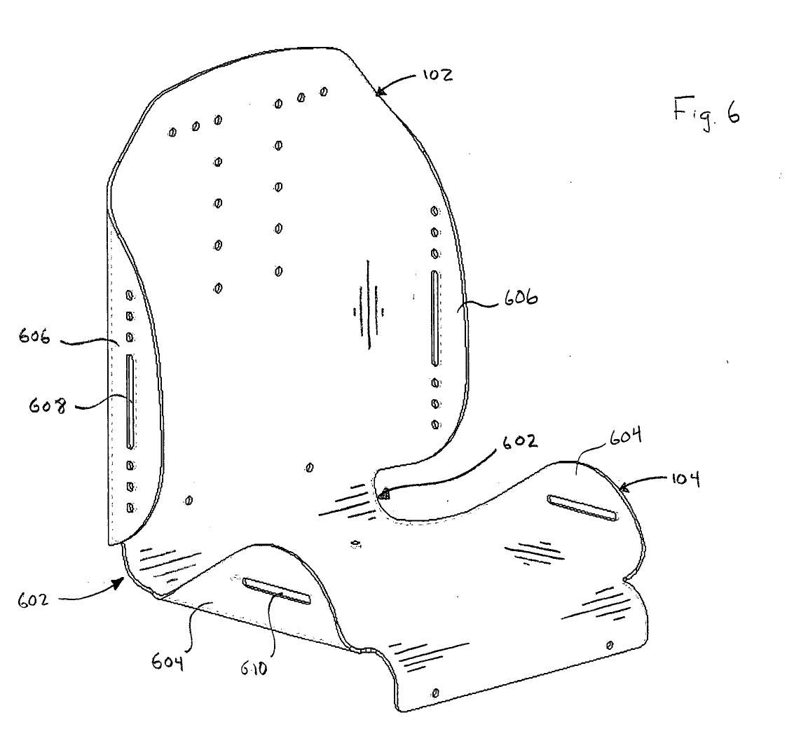

Illustrated in FIG. 6 is a perspective view of chair assembly with backrest 102 and seat 104. A transition or notched portion 602 is provided between backrest 102 and seat 104 to allow the once piece chair assembly to tilt. In this embodiment, the notched portion 602 has a reduced width compared to backrest 102 and seat 104 thereby forming a flexible joint between the two portions of the chair assembly.

Backrest 102 also includes flanges 606. Flanges 606 are disposed on distal side portions of backrest 102 and can provide lateral support to a user when seated. Flanges 606 include apertures and slots 608 for releasable attachment to, for example, arms 120. Seat 104 includes flanges 604 disposed on its distal side portions. Similar to flanges 606, flanges 604 also include apertures and slots 610 for releasable attachment with, for example, arms 120. So configured, slots 608 and 610 allow arms 120 to be connected in various positions along the slots to vary the relative angle between backrest 102 and seat 104. For example, FIG. 2 shows arms 102 maintaining a substantially 90 degree angle between backrest 102 and seat 104.

As specifically shown in FIG. 2, the rear seat-to-floor height can be adjusted via a bracket 212. Bracket 212 includes a pivotable connection 218 at one end that is connected to the bottom of seat 104 and an elongated slot 214 distal thereto. A fastener 216 is accepted into slot 214 and can be tightened down onto bracket 212 to adjust and lock its position with respect to slot 214. Once tightened, fastener 216 prevents bracket 212 from further movement with respect to frame 200. By adjusting within slot 214 the position of fastener 216, the rear seat-to-floor height is adjusted.

As described above, the chair assembly and frame can be manufactured from a single piece of material. In this embodiment, a single piece of appropriately sized sheet metal can be efficiently cut and formed by bending and welding so to result in both components fabrication. For example, a two dimensional sheet of metal can be laser cut with the appropriate pattern and layout for the chair assembly and frame. Thereafter, each component is bent into its three-dimensional shape and welded, brazed, bolted or riveted where necessary to retain its shape and add strength.

Referring once again to FIG. 2, the embodiment of wheelchair 100 provides a stable and highly maneuverable platform for users. In particular, with the battery assembly 112 removed and a user sitting in wheelchair 100, the overall center of gravity of user and wheelchair is laterally positioned at approximately location CG₁. Location CG₁ is approximately above the main drive wheels 114, which assists the traction ability of drive wheels 114. When battery assembly 112 is then placed in its compartment on frame 200, the overall center of gravity shifts laterally to a position somewhere rearward of location CG₁ such as, for example, location CG₂. Such a lateral position provides good degree of forward and rearward stability and maneuverability to wheelchair 100. Furthermore, location CG₂ is proximate to the lateral position of the user's shoulders 210, as indicated by location S. By having the overall center of gravity proximate to the user's shoulders 210 and having the user's shoulders 210 approximately above or nearly above the drive wheels 114, wheelchair 100 maneuvers in a fashion is intuitive to the user.

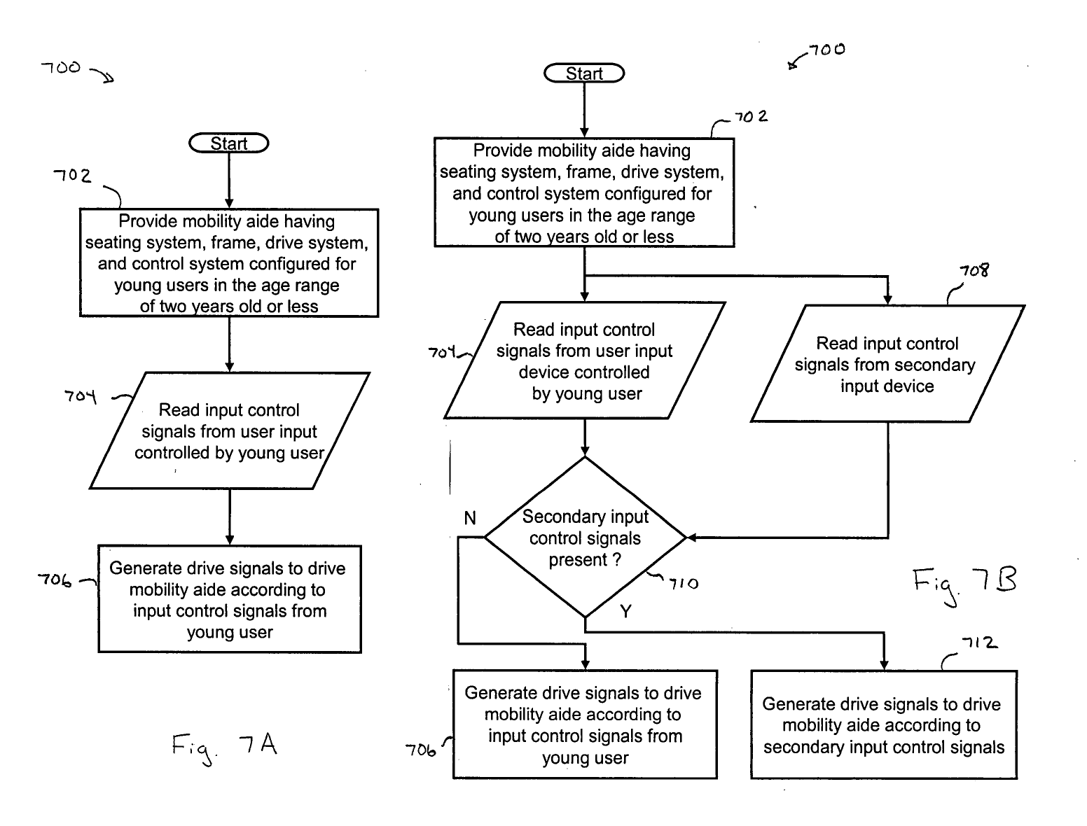

Wheelchair 100 may be constructed and dimensioned for use by very young individuals ranging from possibly 18 months of age and upwards. By allowing young individuals the freedom of movement at as early a stage in life as possible, the cognitive facilities associated with mobility at such a critically young age may be promoted and encouraged. In another embodiments, methods of promoting the cognitive abilities of a very young user are provided and illustrated in FIGS. 7A and 7B.

According to the embodiment of FIG. 7A, the method 700 starts in step 702 by providing a power mobility aide such as, for example, a wheelchair having a seating system, frame, drive system, and control system configured for a young user in the age range of two years old or less. Step 704 reads input control signals from a user input device controlled by the young user, which may be a joystick or head array device. Step 706 generates drive signals to drive the mobility aide according to the input control signals from the young user.

The embodiment of FIG. 7B is similar except that steps 708, 710, and 712 have been added. Step 708 reads the input control signals from a secondary input device. This secondary input device can be a remotely controlled joystick or other controller that is controlled by a parent, guardian, or attendant. The remotely controlled input device is connected to the electronics box of the mobility aide. Step 710 determines if input control signals from the secondary input control device are present or existent. If yes, step 712 generates drive signals to drive the mobility aide according to the secondary input device control signals and overrides any signals generated by the young user input control device. If no, step 706 generates drive signals to drive the mobility aide according to the input control signals from the young user.

According to these embodiments, an early intervention into a young user's life to allow such a user to independently move or transport themselves is provided thereby promoting normal cognitive growth and development that is imparted through independence of movement. Furthermore, such an early introduction into independent movement facilitates smoother transitions by the young users into larger and more sophisticated power mobility aides as they grow into adolescence and adulthood. By reducing the reliance on others for movement at a very young age, a user's cognitive development abilities may be promoted in circumstances where it otherwise would not be promoted.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, seat frame or side frame can have different geometries from that shown herein, tray 122 can be omitted, and joystick 124 can be attached via a remote cable for attendant control of the wheelchair. Still further, clamps or other fasteners can be used to facilitate connections between components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

1. A wheelchair comprising:
a frame having:
first and second side portions;
a seat assembly support portion;
a battery support portion substantially rearward of the seat assembly support portion; and
at least one drive wheel and at least one caster assembly supporting the wheelchair.

2. The wheelchair of claim 1 wherein the battery support portion comprises a recess configured to accept at least a portion of at least one battery.

3. The wheelchair of claim 1 wherein the battery support portion comprises a location rearward of the seat assembly support portion.

4. The wheelchair of claim 1 wherein the battery support portion comprises a caster assembly attachment portion.

5. The wheelchair of claim 1 wherein the battery support portion comprises at least a portion of a wall of the first and second side portions.

6. The wheelchair of claim 1 wherein the battery support portion comprises at least one electrical connector.

7. The wheelchair of claim 1 wherein the frame comprises a one-piece material construction.

8. The wheelchair of claim 1 wherein the first and second side portions comprise a drive wheel assembly mounting portion having at least one slot and apertures.

9. The wheelchair of claim 1 further comprising a seat assembly having one-piece frame that includes a seat potion, back portion and a transition portion between the seat portion and the back portion, the transition portion comprising a notched portion therein.

10. The wheelchair of claim 9 wherein the back portion comprises projecting side flanges having at least one aperture.

11. The wheelchair of claim 9 wherein the seat portion comprises projecting side flanges having at least one opening.

12. The wheelchair of claim 1 further comprises a side arm portion connected to the seat portion and the back portion.

13. The wheelchair of claim 12 wherein the side arm portion is configured to adjust the angle between the seat portion and the back portion.

14. The wheelchair of claim 12 wherein the side arm portion comprises an angled bracket attached to the seat portion and the back portion.

15. A wheelchair comprising:
a first frame means for supporting a seat assembly and at least one drive assembly;
a second frame means for supporting at least one battery; the second frame means comprising a location substantially rearward of the first frame means so as to allow said at least one battery to serve as a counterweight to the seat assembly and the at least one drive assembly supported by the first frame means.

16. The wheelchair of claim 15 further comprising a control means for controlling the at least one drive assembly.

17. The wheelchair of claim 15 further comprising a means for connecting the at least one battery to the at least one drive assembly.

18. A method of promoting cognitive ability in young users of wheelchairs, the method comprising:
providing a power wheelchair having a seating system, frame, drive system, and control system configured for a young user in the age range of less than two years old;
receiving input control signals from a user input device controlled by the young user; and
generating drive signals to drive the wheelchair according to the input control signals from the young user.

19. The method of claim 18 wherein the step of receiving input control signals from a user input device controlled by the young user comprises receiving input control signals from a joystick input device.

20. The method of claim 18 wherein the step of receiving input control signals from a user input device controlled by the young user comprises receiving input control signals from a head array input device.

21. A method of promoting cognitive ability in young users of mobility aides, the method comprising:
providing a power mobility aide having a seating system, frame, drive system, and control system configured for a young user in the age range of two years old or less;
receiving input control signals from a user input device controlled by the young user;
generating drive signals to drive the mobility aide according to the input control signals from the young user;
receiving input control signals from a secondary input device; and
generating drive signals to drive the mobility aide according to the input control signals from the secondary input device that override the drive signals generated according to the user input device.

22. The method of claim 21 wherein receiving input control signals from a secondary input device comprises receiving input control signals from a parental input device.

23. The method of claim 21 wherein receiving input control signals from a secondary input device comprises receiving input control signals from an attendant input device.

24. The method of claim 21 wherein the step of receiving input control signals from a user input device controlled by the young user comprises receiving input control signals from a joystick input device.

25. The method of claim 21 wherein the step of receiving input control signals from a user input device controlled by the young user comprises receiving input control signals from a head array input device.
